(19) United States
(12) Patent Application Publication
(10) Pub. No.: US 2025/0056458 A1
(43) Pub. Date: Feb. 13, 2025

(54) DECOUPLED UPLINK AND DOWNLINK FOR TIMING PRECOMPENSATION

(71) Applicant: Nokia Technologies Oy, Espoo (FI)

(72) Inventors: Rafhael MEDEIROS DE AMORIM, Aalborg (DK); Enric JUAN, Aalborg (DK)

(73) Assignee: Nokia Technologies Oy, Espoo (FI)

(21) Appl. No.: 18/799,308

(22) Filed: Aug. 9, 2024

(30) Foreign Application Priority Data
Aug. 10, 2023 (GB) 2312265.8

(51) Int. Cl. H04W 56/00

(52) U.S. Cl. CPC H04W 56/0045; H04W 56/0015

(57) ABSTRACT

In accordance with example embodiments of the invention there is at least a method an apparatus to perform based on determining an routing point switch in a communication network by a serving base station from a source routing point to a target routing point: creating a pre-compensation transition window for start and end of transition time between an availability of the source routing point and an availability of the target routing point, wherein the creating is starting at a point in time and using a duration of the pre-compensation transition window on at least an uplink transmission with the target routing point and at least a downlink reception from the source routing point; and based on the pre-compensation transition window, performing at least one of time or frequency pre-compensation to accommodate for time differences at the serving base station at least one of during or after the routing point switch and for differences in a propagation path between the source routing point and the target routing point to at least maintain continuity of communication by the apparatus during the start and end of transition time.

### TECHNICAL FIELD

The teachings in accordance with the exemplary embodiments of this invention relate generally to configuring behavior of a user equipment in a communication network to allow for uplink continuity on transmission. and, more specifically, relate to a new machine learning-dedicated bearer for machine learning or artificial intelligence related configuring of a behavior of a user equipment in routing point switching in a communication network to allow for uplink continuity on transmission, by creating a time and/or frequency pre-compensation “transition window.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
3GPP: 3^{rd} Generation Partnership Project
DL: Downlink
gNB: Base station of 5G system
GNSS: Global Navigation Satellite System
NTN: Non Terrestrial Networks
RAN: Radio access network
RTT: Round Trip Time
Rx: Receiver (or receive)
SIB: System Information Broadcast
TA: Timing Advance
TN: Terrestrial Network
Tx: Transmitter (or transmit)
UE: User Equipment
UL: Uplink

There has been challenges to routing operations in communication networks such as 4G, 5G, or 6G networks etc. Routing operations in these communication systems must be compatible with many existing network techniques and principles, such as Internet Protocol or network based routing, existing network-based mobility functions, and even satellite system communications to name only a few.

At this time constellations of geosynchronous satellites are being used to establish communication systems between each other and/or ground terminals, stations or other devices on the Earth. Satellites may be classified according to altitude, orbit and/or other parameters, with some of the more common classifications including: Low Earth orbit (LEO); Medium Earth orbit (MEO); High Earth orbit (HEO); Semi-synchronous orbit (SSO); Geosynchronous orbit (GEO); Geostationary orbit (GSO) and Areostationary orbit (ASO). In addition to spacing required to avoid physical collisions, satellites may require some amount of orbital spacing or angular spacing to avoid interferences resulting from signals overlapping or otherwise colliding with each other. In communications technologies such as 5G and LTE these events can lead to satellite switching by a ground base station.

Example embodiments of this invention propose improved operations for such satellite and routing point operations.

### SUMMARY

This section contains examples of possible implementations and is not meant to be limiting.

In another example aspect of the invention, there is an apparatus, such as a user equipment side or a network side apparatus, comprising: at least one processor; and at least one non-transitory memory storing instructions, that when executed by the at least one processor, cause the apparatus at least to: based on determining a routing point switch in a communication network by a serving base station from a source routing point to a target routing point: create a pre-compensation transition window for start and end of transition time between an availability of the source routing point and an availability of the target routing point, wherein the creating is starting at a point in time and using a duration of the pre-compensation transition window on at least an uplink transmission with the target routing point and at least a downlink reception from the source routing point; and based on the pre-compensation transition window, perform at least one of time or frequency pre-compensation to accommodate for time differences at the serving base station at least one of during or after the routing point switch and for differences in a propagation path between the source routing point and the target routing point to at least maintain continuity of communication by the apparatus during the start and end of transition time.

In still another example aspect of the invention, there is a method, comprising: based on determining an routing point switch in a communication network by a serving base station from a source routing point to a target routing point: creating a pre-compensation transition window for start and end of transition time between an availability of the source routing point and an availability of the target routing point, wherein the creating is starting at a point in time and using a duration of the pre-compensation transition window on at least an uplink transmission with the target routing point and at least a downlink reception from the source routing point; and based on the pre-compensation transition window, performing at least one of time or frequency pre-compensation to accommodate for time differences at the serving base station at least one of during or after the routing point switch and for differences in a propagation path between the source routing point and the target routing point to at least maintain continuity of communication by the apparatus during the start and end of transition time.

A further example embodiment is an apparatus and a method comprising the apparatus and the method of the previous paragraphs, wherein at least one of the source routing point or the target routing point is embodied in an aerospace device, wherein a timing advance value is considered for a timing advance calculation before, during, and after the pre-compensation transition window, wherein there is during the pre-compensation transition window: applying a timing advance corresponding at least to a delay between the apparatus and an uplink synchronization reference point associated with the source routing point; applying at least one of a time advance delay between the apparatus and the uplink synchronization reference point associated to the target routing point or an interruption time if applicable, wherein there is applying after the pre-compensation transition window a calculation of round trip time between the apparatus and the uplink synchronization ref point associated with the target routing point, wherein after the pre-compensation transition window a downlink and an uplink having a same round trip time are coupled and associated to the target routing point, and wherein the timing advance is equal to the round trip time between the uplink synchronization ref point associated to the target routing point, wherein there is during the pre-compensation transition window, applying a timing advance equal to a delay between the apparatus and an uplink synchronization reference point associated to the source routing point, wherein an uplink transmission associated with a target routing point and a downlink reception associated with a source routing point have different paths or delays; and applying the delay between the apparatus and an uplink synchronization ref point associated to the target routing point, wherein there is applying an interruption time if applicable, wherein there is prior to the serving cell switch and based on the transition window, calculating a round trip time based on a decoupling between uplink and downlink routing points; in the pre-compensation transition window calculate a downlink delay reference from source routing point information and a path delay from target routing point information, wherein the calculating comprise a timing advance, wherein during the transition period, a downlink reference is received from the source routing point, and an uplink reference is a signal sent towards the target routing point for downlink and uplink decoupling; and after the transition window, calculate a round-trip time towards the target routing point, wherein the calculating comprises timing, wherein a parameter is introduced when a gap in time is configured at the serving base station to accommodate for an offset between a difference in a total distance when information is routed through the source routing point and the target routing point, wherein there is receiving an indication of a time when the target routing point will become available, wherein there is receiving parameters of a start and the duration of the transition window from the serving base station, wherein the parameters are implicitly conveyed, wherein there is starting transmission towards the target routing point at a time T before a service time is reached, wherein T is calculated from routing point assistance information provided for at least one of a source cell or a target cell, wherein a duration of the transition window is measured in slots, wherein there is receiving from the serving base station a gap to be used to accommodate for time differences at serving base station side before, during, or after the switch, wherein there is receiving from the serving base station, an indication to maintain or to reset a value of N_{TA} during at least one of the transition time or after the switch is completed, wherein there is receiving from the serving base station, an indication to be precluded from RACH-less hard switch and to perform a new random access channel, and/or wherein there is receiving, from the communication network, an indication of the point in time to create the pre-compensation transition window.

A non-transitory computer-readable medium storing program code, the program code executed by at least one processor to perform at least the method as described in the paragraphs above.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an example architecture of a non-terrestrial network;

FIG. 2A shows satellite switching where the serving gNB does not change;

FIG. 2B shows a resulting downlink frame i and an uplink frame i at T_{TA};

FIG. 3 shows slot count relationships in DL and UL at a given point in the NTN system of the example;

FIG. 4 shows downlink (DL) and uplink (UL) activity from/towards the serving satellite by the gNB and UE when t-service is reached at the end of gNB slot n;

FIG. 5 shows in the left, the propagation path to be considered by the UE for pre-compensation assumes the access or routing point through the source satellite is to be used for timing advance pre-compensation, and in the right, during the transition period, the UE assumes a decoupling between UL and DL paths when performing the timing pre-compensation;

FIG. 6 shows a high level block diagram of various devices used in carrying out various aspects of the invention; and

FIG. 7 shows a method in accordance with example embodiments of the invention which may be performed by an apparatus.

### DETAILED DESCRIPTION

In example embodiments of this invention there is proposed at least a method and apparatus for a new machine learning-dedicated bearer for machine learning or artificial intelligence related to configuring a behavior of a user equipment in routing point switching in a communication network to allow for uplink continuity on transmission, including by creating a time and/or frequency pre-compensation “transition window.

The feasibility of using 5G NR standards to support non-terrestrial networks has been studied during 3GPP releases in standards at the time of this application. In these standards the UEs supporting NTN are assumed to have GNSS capability [1]. In an NTN system, 5G base stations (gNB) or gNB functionality are deployed on board satellites or relayed by gNBs in a transparent way to provide communication coverage over a very large area that may be otherwise unreachable by cellular networks. Such functionality can be used to connect IoT devices globally as well as provide personal communication in remote areas and in disaster relief.

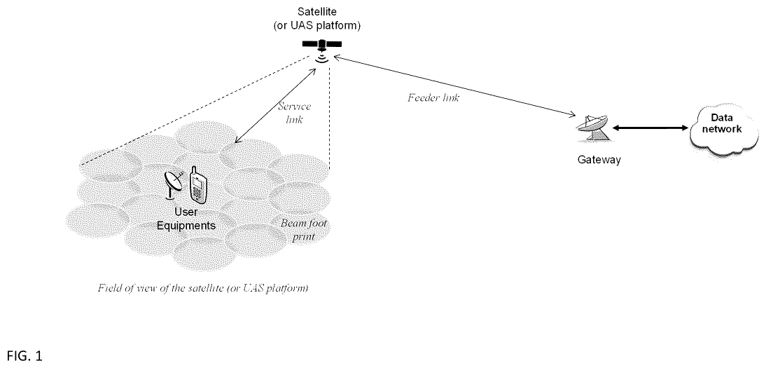

FIG. 1 shows an example NTN scenario. As shown in FIG. 1 there is a field of view of the satellite (or UAS platform) with a service link with a satellite (or UAS platform) that has a feeder link to a data network gateway.

There are different types of satellite orbits that have been studied for NR access including Low Earth Orbit (LEO) satellites which orbit at approximately 600 km above the earth. LEO is assumed to be the most interesting business case from Nokia's perspective (compared with higher orbits like geostationary satellites). For standards it was proposed the typical beam footprint size for a LEO satellite was assumed to be between 100-1000 km radius [2]. So one LEO satellite can cover a very large area on the Earth which may include multiple countries.

In standards at the time of this application, the topic of unchanged PCI was introduced (or is being considered for introduction in 3GPP) with the goal of reducing the signaling overhead and simplify RRC procedures for the UE. The working principle is that after a satellite switching, the serving gNB (on ground) does not change and, therefore, the (majority of the) cell configuration can be kept without changing the PCI, frequency, and other cell configuration parameters (e.g., servingCellconfigCommon). Then, the satellite switching is almost transparent for the UE, which is not required to perform L3 mobility (i.e., handover procedure) and it does not need to update the security key.

The conditions for the mechanism to work are:
NTN cells must be deployed as quasi-Earth fixed cells (EFC) since the cell coverage's area should not change,
The network (NW) should indicate the UE how/when to perform DL and UL synchronization after satellite switching, or
The network would accept an interruption gap for the UE to detect the new timing and adapt to this.

In standards at the time of this application the focus is on transparent architecture and the most obvious case is when the cells are provided by the same gNB, i.e. the same cell with the fixed PCI is provided by the same gNB, so only the satellite node is changed.

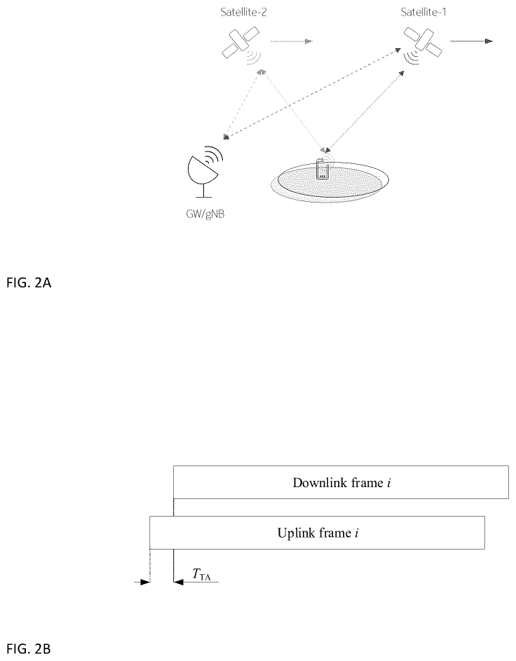

FIG. 2A shows an example of satellite switching where PCI is kept unchanged in a transparent-based EFC deployment.

The following steps will take place during the satellite switching:
1. The UE, which is stationary, is being served by Satellite-1 (i.e., blue cell),
2. As Satellite-1 moves away from the UE and Satellite-2 gets closer, the NW indicates when the satellite switching will occur and how to perform re-synchronization to the new cell,
3. Once Satellite-2 takes over (orange cell), the UE performs DL/UL synchronization operations to re-connect.

Even though the UE is being served by a new satellite, it does not change the serving gNB so it can keep the cell configuration. Satellite-1 and Satellite-2 are configured with the same PCI, same UE context and same protocol stack (including SSB generation, coding/decoding, modulation/demodulation, same CORESET configuration, and switch routing). However, from the UE's reference, Satellite-1 and Satellite-2 introduce different frequency (i.e., Doppler) and timing drifts.

In standards at the time of this application at least hard satellite switching with unchanged PCI and without L3 mobility was agreed to be supported. However, no explicit details have been decided so far.

Currently, in NTN, the UE is responsible to perform time and frequency pre-compensation on UL transmissions, utilizing the ephemeris and common delay information broadcast by the gNB to perform the calculations related to the feeder link and service link compensation.

The behavior of the UE regarding the pre-compensation is found across the 3GPP specifications as indicated as follows below.

In standards at the time of this application, the timing of the UL frame in NTN is said to be advanced in relation to the DL timing by a factor of T_{TA}=(N_{TA}+N_{TA,offset}+N_{TA,adj}^{common}+N_{TA,adj}^{UE})T_{c}, where the components N_{TA,adj}^{common} and N_{TA,adj}^{UE} are NTN specific.

From these standards: Downlink, uplink, and sidelink transmissions are organized into frames with T_{f}=(ΔfₘₐₓN_{f}/100)·T_{c}, 10 ms duration, each consisting of ten subframes of T_{sf}=(ΔfₘₐₓN_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier.

Uplink frame number i for transmission from the UE shall start T_{TA}=(N_{TA}+N_{TA,offset}+N_{TA,adj}^{common}+N_{TA,adj}^{UE})T_{c} before the start of the corresponding downlink frame at the UE where:
N_{TA} and N_{TA,offset} are given by clause in the standards, except for msgA transmission on PUSCH where N_{TA}=0 shall be used;
N_{TA,adj}^{common} given by clause in the standards that is derived from the higher-layer parameters TACommon, TACommonDrift, and TACommonDriftVariation if configured, otherwise N_{TA,adj}^{common}=0;
N_{TA,adj}^{UE} given by clause in the standards that is computed by the UE based on UE position and serving-satellite-ephemeris-related higher-layers parameters if configured, otherwise N_{TA,adj}^{UE}=0.

FIG. 2B shows a resulting downlink frame i and an uplink frame i at T_{TA}.

In standards at the time of this application, there are instructions in how the UE should proceed to use the information related to the UL synchronization relative to the serving satellite to perform UL synchronization.

From standards at the time of this application Transmission timing adjustments [ . . . ] Using higher-layer ephemeris parameters for a serving satellite, if provided, a UE pre-compensates the two-way transmission delay on the service link based on N_{TA,adj}^{UE} that the UE determines using the serving satellite position and its own position. To pre-compensate the two-way transmission delay between the uplink time synchronization reference point and the serving satellite, as in the standards the UE determines N_{TA,adj}^{common} based on one-way propagation delay Delay_{common}(t) that the UE determines as:

$${Delay}_{common} ( t ) = \frac{{TA}_{Common}}{2} + \frac{{TA}_{CommonDrift}}{2} \times ( t - {t}_{epoch} ) + \frac{{TA}_{Common DriftVariant}}{2} \times {( t - {t}_{epoch} )}^{2}$$

where TA_{Common}, TA_{CommonDrift}, and TA_{CommonDriftVariant} are respectively provided by ta-Common, ta-CommonDrift, and ta-CommonDriftVariant and t_{epoch} is the epoch time of TA_{Common}, TA_{CommonDrift}, and TA_{CommonDriftVariant} Delay_{common}(t) provides a distance at time t between the serving satellite and the uplink time synchronization reference point divided by the speed of light. The uplink time synchronization reference point is the point where DL and UL are frame aligned with an offset given by N_{TA,offset}.

Finally, standards at the time of this application indicate the accuracy required on the UE timing pre-compensation, based on the presence of DL signals and define the DL reference signal as the point in time where the DL frame is received by the UE.

The UE initial transmission timing error shall be less than or equal to ±T_{e_NTN} where the timing error limit value T_{e_NTN} is specified in standards. This requirement applies:
when it is the first transmission in a DRX cycle for PUCCH, PUSCH and SRS, or it is the PRACH transmission, or it is the msgA transmission.

The UE shall meet the T_{e_NTN} requirement for an initial transmission provided that at least one SSB is available at the UE during the last 160 ms. and the UE has a validity time running for N_{TA,common} and N_{TA,UE-specific}. The reference point for the UE initial transmit timing control requirement shall be the downlink timing of the reference cell minus (N_{TA}+N_{TA-offset}+N_{TA,adj}^{common}+N_{TA,adj}^{UE})×T_{c}.

The downlink timing is defined as the time when the first path (in time) of the corresponding downlink frame used by the UE to determine downlink timing is received from the reference cell at the UE antenna.

N_{TA} for PRACH is defined as 0. (N_{TA}+N_{TA-offset}+N_{TA,adj}^{common}+N_{TA,adj}^{UE})×T_{c} (in T_{c} units) for other channels is the difference between UE transmission timing and the downlink timing immediately after when the last timing advance in clause 7.3 was applied. or after the last update in N_{TA,adj}^{common} or N_{TA,adj}^{UE}.

In the unchanged PCI scenario, the satellite switching occurs transparently to the UE. That means that the UE switches from source satellite access node to a target satellite access node without performing L3 mobility and without changing serving gNB. Though some example embodiments of this invention target the hard satellite switch case, the same proposed amendments in accordance with example embodiments of the invention are valid for a soft satellite switch.

The fundamental problem being addressed by example embodiments of this invention is that due to the very large propagation delays the one-way delay in both DL and UL in NTN will usually correspond to several slots. For example, consider the case where:
The feeder link delay (delay between the gateway for the gNB on earth and the satellite), t₁, corresponds to x₁ slots, where:

$${x}_{1} = ⌊ \frac{{t}_{1}}{{t}_{slot}} ⌋ ,$$

and tₛₗₒₜ is the duration of one slot,
Likewise, the service link delay (delay between the satellite and the UE), t₂, corresponds to x₂ slots.

For the example to be described in this section, the value of N_{TA} and N_{TA-offset} is considered to be equal to zero. However, this is not always the case. This does not alter the general idea being presented, and those values may be reintroduced in the calculation without prejudice for the idea being presented.

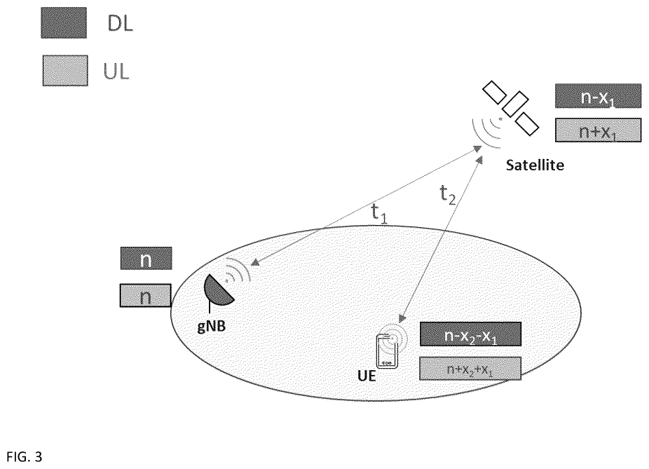

In this situation, assuming for simplicity and without loss of generality, DL and UL slot numbering alignments at the gNB, the following relationships in the slot numbering are observed in the system at a given point in time (see FIG. 3):
In the satellite:
   the DL slot (in blue) is delayed by x1 slots relative to the slot being transmitted by the gNB (i.e., n−x1);
   the UL slot (in green) is advanced by x1 slots relative to the slot being currently received by the gNB (i.e., n+x1);
In the UE:
   the DL slot being received by the UE is x1+x2 slots delayed relative to the slot being transmitted by the gNB (i.e., n−[x1+x2]);
   the UL slot transmitted by the UE is advanced by x1+x2 slots relative to the slot being currently received by the gNB (i.e., n+[x1+x2]).

FIG. 3 shows slot count relationships in DL and UL at a given point in the NTN system of the example.

The parameter t-service in the technical specifications represent the point in time where a given satellite will stop serving one area. This means that the satellite will no longer cover, in the example of FIG. 3, the UE indicated in the figure.

In this case, if the time indicated by the parameter t-service is reached when the slot n is transmitted by the gNB, i.e., at the exact point in time indicated in FIG. 3, a few considerations need to be made:
At UL side:
   the slots between (n and n+x1] will have been already transmitted by the satellite, before t-service is reached;
   but they will have not reached the gNB before t-service is reached.
At DL side:
   the DL slots between [n−x1 and n−x1−x2] will have been already transmitted by the satellite towards the UE, before t-service is reached;
   but they will have not reached the UE before t-service is reached.

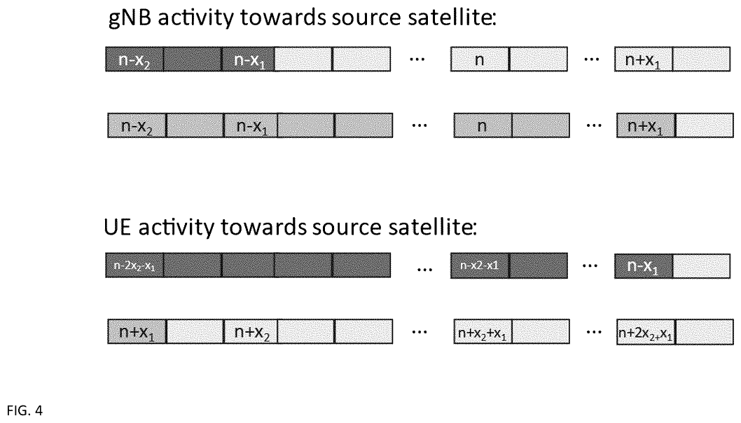

This also indicates that the gNB has to stop the DL transmission towards the current serving satellite x1 slots before slot n, i.e., at slot n−x1, as this is the last slot that can be reached by the UE using this satellite. Likewise, the UE has to stop transmission towards the target satellite x2 slots before t-service is actually reached. The slot given by n+x1 is the last slot that can be received by the gNB. This is depicted in FIG. 4.

FIG. 4 shows downlink (DL) and uplink (UL) activity from/towards the serving satellite by the gNB and UE when t-service is reached at the end of gNB slot n.

For service continuity or just continuity, in the hard switch of satellites, UE shall start UL transmissions towards the target satellite at slot n+x₁+1. The problem, though, is that for an extended period of time (until UL slot n+2x₂+x1), the UE is not receiving the synchronization signals from the target satellite, but solely the information from the source satellite.

in accordance with example embodiments of the invention, the behavior of the UE is amended to allow for UL continuity on transmission, by creating a time and/or frequency pre-compensation “transition window”. In this transition window the UE calculates the RTT by assuming a decoupling between UL and DL access or routing points. Assuming, for transparent architectures that the gNB is the same, the time and frequency in UL at the gNB side might not be changed.

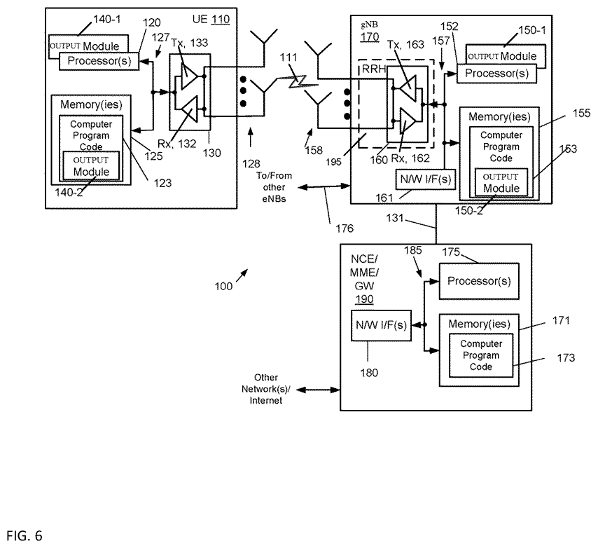

Before describing the example embodiments as disclosed herein in detail, reference is made to FIG. 6 for illustrating a simplified block diagram of various electronic devices that are suitable for use in practicing the example embodiments of this invention.

FIG. 6 is a block diagram of one possible and non-limiting system in which the example embodiments may be practiced.

Turning to FIG. 6, this figure shows a block diagram of one possible and non-limiting example in which the examples may be practiced. A user equipment (UE) 110, and a radio access LTE, 5G, or 6G network base station i.e., gNB 170, and NCE/MME/GW 190 are illustrated. In the example of FIG. 6, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a output module 140, comprising one of or both parts 140-1 and/or 140-2, which may be implemented in a number of ways. The output module 140 may be implemented in hardware as output module 140-1, such as being implemented as part of the one or more processors 120. The output module 140-1 may be implemented also as an integrated circuit or through other hardware such as a programmable gate array. In another example, the output module 140 may be implemented as output module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB 170 in this example is a base station that provides access by wireless devices such as the UE 110 to the wireless network 100. The gNB 170 may be, for example, a base station for 5G, also called New Radio (NR). In 5G, the gNB 170 may be a NG-RAN node, which is defined as either a gNB or an ng-eNB. A gNB is a node providing NR user plane and control plane protocol terminations towards the UE, and connected via the NG interface to a 5GC (such as, for example, the NCE/MME/GW 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the gNB 170 and centralized elements of the gNB 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The gNB 170 may also be an eNB (evolved NodeB) base station, for LTE (long term evolution), or any other suitable base station or node.

The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The gNB 170 includes a output module 150, comprising one of or both parts 150-1 and/or 150-2, which may be implemented in a number of ways. The output module 150 may be implemented in hardware as output module 150-1, such as being implemented as part of the one or more processors 152. The output module 150-1 may be implemented also as an integrated circuit or through other hardware such as a programmable gate array. In another example, the output module 150 may be implemented as output module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. Note that the functionality of the output module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 receiver for gNB implementation for 5G, with the other elements of the gNB 170 possibly being physically in a different location from the RRH/DU, and the one or more buses 157 could be implemented in part as, for example, fiber optic cable or other suitable network connection to connect the other elements (e.g., a central unit (CU), gNB-CU) of the gNB 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality. Further, this NCE/MME/GW 190 can for example perform Access & Mobility Management Function (AMF), Location Management Function (LMF), Mobility Management Entity (MME), Network Control Element (NCE), Policy Control Function (PCF), Serving Gateway (SGW), Session Management Function (SMF), and Unified Data Management (UDM). The NCE/MME/GW 190 provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the NCE/MME/GW 190, and note that both 5G and LTE functions might be supported. The gNB 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, NCE/MME/GW 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of output modules 140-1, 140-2, 150-1, and 150-2 may be configured to implement high level syntax for a compressed representation of neural networks based on the examples described herein. Computer program code 173 may also be configured to implement high level syntax for a compressed representation of neural networks based on the examples described herein.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, in accordance with example embodiments of the invention, the behavior of the UE is amended to allow for UL continuity on transmission, by creating a time and/or frequency pre-compensation “transition window”. In this transition window the UE calculates the RTT by assuming a decoupling between UL and DL access or routing points. Assuming, for transparent architectures that the gNB is the same, the time and frequency in UL at the gNB side might not be changed.

In accordance with example embodiments of the invention a user equipment (UE) will perform time synchronization as follows:
Prior to switch: calculate the round-trip time towards the source satellite:
   Timing advance (source cell)=2(t₁+t₂);
In the transition window: DL delay reference calculated from source satellite information; UL path delay calculated from target satellite:
   Timing advance=t₁+t₂+t₃+t₄+[t_{gap}],
   During the transition period, the DL reference is still the signal received from the source satellite. At the same time, the UL reference is a new signal sent towards the target satellite (i.e., DL and UL decoupling);
After the transition window: calculate the round-trip time towards the target satellite:
   timing advance (target cell)=2(t₃+t₄)

Where t_{gap} is an optional parameter to be introduced when a gap in time is configured at the gNB to accommodate for the offset between the difference in the total distance in the physical layer when information is routed through the source and target satellites.

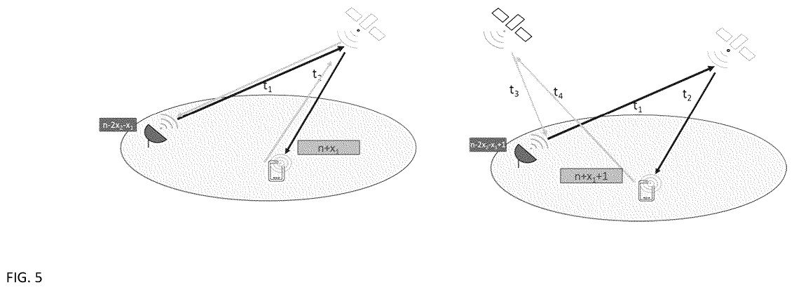

Alternatively, in accordance with example embodiments of the invention the UE could be indicated the time when the target satellite will become available, i.e. t-start. In that case, t-gap could be inferred by the UE (i.e., t-gap=t-start−t-service). The times t₃ and t₄ correspond to the feeder link and service link delay calculated towards the target satellite as indicated in FIG. 5.

FIG. 5 shows in the left, the propagation path to be considered by the UE for pre-compensation assumes an access point or a routing point through the source satellite or routing point is to be used for timing advance pre-compensation, and in the right, during the transition period, the UE assumes a decoupling between UL and DL paths when performing the timing pre-compensation.

An important factor for the UE is to understand the start of the transition time and the end (or the total duration) of the transition window.

Operations in accordance with example embodiments of the invention include:
1. The start and the duration of the transition window might be configured by the gNB,
   These parameters can also be implicitly conveyed:
      In our example the UE starts the transmission towards the target satellite at x₂ slots (at a time t₂) before t-service is reached. And the duration of the transition window is 2t₂ (2x₂) when measured in slots.
2. The gNB may configure a gap to be used by the UE to accommodate for time differences at gNB side before and after the switch;
3. In case N_{TA}, is different from zero, the UE can be informed by the gNB whether to maintain or to reset the value of N_{T}A during the transition time or/and after the switch is completed:
   The UE with a large value of N_{T}A may also be precluded from RACH-less hard switch and might be requested to perform a new RACH;
4. For the cases N_{TA,offset} is different from zero, the value has to be considered for the timing advance calculation before, during and after the transition periods.

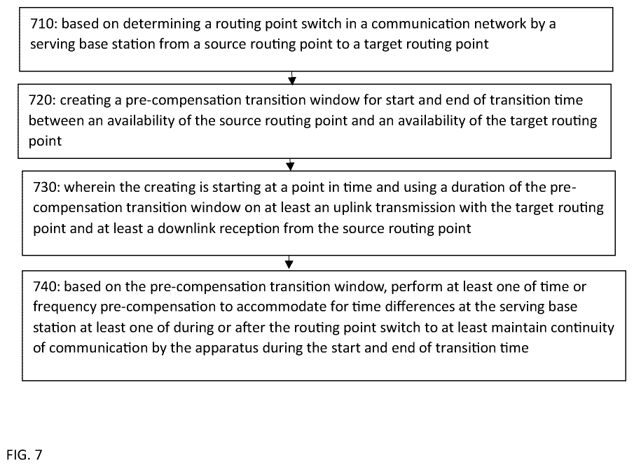

FIG. 7 shows a method in accordance with example embodiments of the invention which may be performed by an apparatus.

FIG. 7 illustrates operations which may be performed by a device such as, but not limited to, a device such as a network device (e.g., the UE 110 as in FIG. 6). As shown in block 710 of FIG. 7 there is based on determining a routing point switch in a communication network by a serving base station from a source routing point to a target routing point. As shown in block 720 of FIG. 7 there is creating a pre-compensation transition window for start and end of transition time between an availability of the source routing point and an availability of the target routing point. As shown in block 730 of FIG. 7 wherein the creating is starting at a point in time and using a duration of the pre-compensation transition window on at least an uplink transmission with the target routing point and at least a downlink reception from the source routing point. Then as shown in block 740 of FIG. 7 there is, based on the pre-compensation transition window, perform at least one of time or frequency pre-compensation to accommodate for time differences at the serving base station at least one of during or after the routing point switch and for differences in a propagation path between the source routing point and the target routing point to at least maintain continuity of communication by the apparatus during the start and end of transition time.

In accordance with the example embodiments as described in the paragraph above, wherein at least one of the source routing point or the target routing point is embodied in an aerospace device.

In accordance with the example embodiments as described in the paragraphs above, wherein a timing advance value is considered for a timing advance calculation before, during, and after the pre-compensation transition window.

In accordance with the example embodiments as described in the paragraphs above, wherein there is prior to an end of or during the pre-compensation transition window where an uplink and downlink are coupled: applying a timing advance to a delay between the apparatus and the uplink synchronization reference point associated with the source routing point; and applying a delay between the apparatus and the uplink synchronization ref point associated to the target routing point and apply an interruption time if applicable.

In accordance with the example embodiments as described in the paragraphs above, there is during the pre-compensation transition window: applying a timing advance corresponding at least to a delay between the apparatus and an uplink synchronization reference point associated with the source routing point; applying at least one of a time advance delay between the apparatus and the uplink synchronization reference point associated to the target routing point or an interruption time if applicable.

In accordance with the example embodiments as described in the paragraphs above, wherein there is applying after the pre-compensation transition window a calculation of round trip time between the apparatus and the uplink synchronization ref point associated with the target routing point.

In accordance with the example embodiments as described in the paragraphs above, wherein after the pre-compensation transition window a downlink and an uplink having a same round trip time are coupled and associated to the target routing point, and wherein the timing advance is equal to the round trip time between the uplink synchronization ref point associated to the target routing point.

In accordance with the example embodiments as described in the paragraphs above, wherein there is during the pre-compensation transition window, apply a timing advance equal to a delay between the apparatus and an uplink synchronization reference point associated to the source routing point.

In accordance with the example embodiments as described in the paragraphs above, wherein an uplink transmission associated with a target node and a downlink reception associated with a source routing point have different paths.

In accordance with the example embodiments as described in the paragraphs above, wherein there is applying the delay between the apparatus and an uplink synchronization ref point associated to the target routing point.

In accordance with the example embodiments as described in the paragraphs above, wherein there is applying an interruption time if applicable.

In accordance with the example embodiments as described in the paragraphs above, wherein there is prior to the serving cell switch and based on the transition window, calculating a round trip time based on a decoupling between uplink and downlink routing points; in the pre-compensation transition window calculate a downlink delay reference from source routing point information and a path delay from target routing point information.

In accordance with the example embodiments as described in the paragraphs above, wherein the calculating comprise a timing advance.

In accordance with the example embodiments as described in the paragraphs above, wherein during the transition period, a downlink reference is received from the source routing point, and an uplink reference is a signal sent towards the target routing point for downlink and uplink decoupling.

In accordance with the example embodiments as described in the paragraphs above, wherein there is after the transition window, calculating a round-trip time towards the target routing point, and wherein the calculating comprises timing.

In accordance with the example embodiments as described in the paragraphs above, wherein a parameter is introduced when a gap in time is configured at the serving base station to accommodate for an offset between a difference in a total distance when information is routed through the source routing point and the target routing point.

In accordance with the example embodiments as described in the paragraphs above, wherein there is receiving an indication of a time when the target routing point will become available.

In accordance with the example embodiments as described in the paragraphs above, wherein there is receiving parameters of a start and the duration of the transition window from the serving base station.

In accordance with the example embodiments as described in the paragraphs above, wherein the parameters are implicitly conveyed.

In accordance with the example embodiments as described in the paragraphs above, wherein there is starting transmission towards the target routing point at a time T before a service time is reached, wherein T is calculated from routing point assistance information provided for at least one of a source cell or a target cell.

In accordance with the example embodiments as described in the paragraphs above, wherein a duration of the transition window is measured in slots.

In accordance with the example embodiments as described in the paragraphs above, wherein there is receiving from the serving base station a gap to be used to accommodate for time differences at serving base station side before and after the switch.

In accordance with the example embodiments as described in the paragraphs above wherein there is receiving from the serving base station, an indication to maintain or to reset a value of N_{TA} during at least one of the transition time or after the switch is completed.

In accordance with the example embodiments as described in the paragraphs above, wherein there is receiving from the serving base station, an indication to be precluded from RACH-less hard switch and to perform a new random access channel.

In accordance with the example embodiments as described in the paragraphs above, wherein there is receiving, from the communication network, an indication of the point in time to create the pre-compensation transition window

In accordance with an example embodiment of the invention as described above there is an apparatus comprising: means, based on determining (one or more transceivers 130, Memory(ies) 125, computer program code 123 and/or output module 140-2, and at least one processor (Processor(s) 120 and/or output module 140-1 as in FIG. 6) an routing point switch in a communication network by a serving base station from a source routing point to a target routing point: for creating (one or more transceivers 130, Memory(ies) 125, computer program code 123 and/or output module 140-2, and at least one processor (Processor(s) 120 and/or output module 140-1 as in FIG. 6) a pre-compensation transition window for start and end of transition time between an availability of the source routing point and an availability of the target routing point, wherein the creating is starting and using (one or more transceivers 130, Memory(ies) 125, computer program code 123 and/or output module 140-2, and at least one processor (Processor(s) 120 and/or output module 140-1 as in FIG. 6) a duration of the pre-compensation transition window on at least an uplink transmission with the target routing point and at least a downlink reception from the source routing point; and means, based on the pre-compensation transition window, for performing (one or more transceivers 130, Memory(ies) 125, computer program code 123 and/or output module 140-2, and at least one processor (Processor(s) 120 and/or output module 140-1 as in FIG. 6) at least one of time or frequency pre-compensation to accommodate for time differences at the serving base station at least one of during or after the routing point switch and for differences in a propagation path between the source routing point and the target routing point to at least maintain continuity of communication by the apparatus during the start and end of transition time.

In the example aspect of the invention according to the paragraph above, wherein at least the means for determining, creating, using, and performing comprises a non-transitory computer readable medium [Memory(ies) 125 as in FIG. 6] encoded with a computer program [computer program code 123 and/or output module 140-2 as in FIG. 6] executable by at least one processor [at least one processor (Processor(s) 120 and/or output module 140-1 as in FIG. 6].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. An apparatus, comprising:
at least one processor; and
at least one non-transitory memory storing instructions, that when executed by the at least one processor, cause the apparatus at least to:
based on determining a routing point switch in a communication network by a serving base station from a source routing point to a target routing point:
create a pre-compensation transition window for start and end of transition time between an availability of the source routing point and an availability of the target routing point,
wherein the creating is starting at a point in time and using a duration of the pre-compensation transition window on at least an uplink transmission with the target routing point and at least a downlink reception from the source routing point; and
based on the pre-compensation transition window, perform at least one of time or frequency pre-compensation to accommodate for time differences at the serving base station at least one of during or after the routing point switch or for differences in a propagation path between the source routing point and the target routing point to at least maintain continuity of communication by the apparatus during the start and end of transition time.

2. The apparatus of claim 1, wherein at least one of the source routing point or the target routing point is embodied in an aerospace device.

3. The apparatus of claim 1, wherein a timing advance value is considered for a timing advance calculation before, during, and after the pre-compensation transition window.

4. The apparatus of claim 1, wherein at least one non-transitory memory storing instructions is executed by the at least one processor to cause the apparatus at least to:
during the pre-compensation transition window:
apply a timing advance corresponding at least to a delay between the apparatus and an uplink synchronization reference point associated with the source routing point; and
apply at least one of a time advance delay between the apparatus and the uplink synchronization reference point associated to the target routing point or an interruption time if applicable.

5. The apparatus of claim 1, wherein the at least one non-transitory memory storing instructions is executed by the at least one processor to cause the apparatus at least to:
apply after the pre-compensation transition window a calculation of round trip time between the apparatus and the uplink synchronization ref point associated with the target routing point.

6. The apparatus of claim 1, wherein after the pre-compensation transition window a downlink and an uplink having a same round trip time are coupled and associated to the target routing point, and wherein the timing advance is equal to the round trip time between the uplink synchronization ref point associated to the target routing point.

7. The apparatus of claim 4, wherein an uplink transmission associated with a target routing point and a downlink reception associated with a source routing point have different paths or delays; and
apply the delay between the apparatus and an uplink synchronization ref point associated to the target routing point.

8. The apparatus of claim 7, wherein the at least one non-transitory memory storing instructions is executed by the at least one processor to cause the apparatus at least to:
apply an interruption time if applicable.

9. The apparatus of claim 1, wherein the at least one non-transitory memory storing instructions is executed by the at least one processor to cause the apparatus at least to:
prior to the serving cell switch and based on the transition window, calculate a round trip time based on a decoupling between uplink and downlink routing points;
in the pre-compensation transition window calculate a downlink delay reference from source routing point information and a path delay from target routing point information;
wherein the calculating comprise a timing advance, and
wherein during the transition period, a downlink reference is received from the source routing point, and an uplink reference is a signal sent towards the target routing point for downlink and uplink decoupling; and
after the transition window, calculate a round-trip time towards the target routing point, wherein the calculating comprises timing.

10. The apparatus of claim 1, wherein a parameter is introduced when a gap in time is configured at the serving base station to accommodate for an offset between a difference in a total distance when information is routed through the source routing point and the target routing point.

11. The apparatus of claim 1, wherein the at least one non-transitory memory storing instructions is executed by the at least one processor to cause the apparatus at least to:
receive an indication of a time when the target routing point will become available.

12. The apparatus of claim 1, wherein the at least one non-transitory memory storing instructions is executed by the at least one processor to cause the apparatus at least to:
receive parameters of a start and the duration of the transition window from the serving base station.

13. The apparatus of claim 11, wherein the parameters are implicitly conveyed.

14. The apparatus of claim 1, wherein the at least one non-transitory memory storing instructions is executed by the at least one processor to cause the apparatus at least to:
start transmission towards the target routing point at a time T before a service time is reached, wherein T is calculated from routing point assistance information provided for at least one of a source cell or a target cell, wherein a duration of the transition window is measured in slots.

15. The apparatus of claim 1, wherein the at least one non-transitory memory storing instructions is executed by the at least one processor to cause the apparatus at least to:
receive from the serving base station a gap to be used to accommodate for time differences at serving base station side before and after the switch.

16. The apparatus of claim 1, wherein the at least one non-transitory memory storing instructions is executed by the at least one processor to cause the apparatus at least to:
receive from the serving base station, an indication to maintain or to reset a value of N_{TA} during at least one of the transition time or after the switch is completed.

17. The apparatus of claim 1, wherein the at least one non-transitory memory storing instructions is executed by the at least one processor to cause the apparatus at least to:
receive from the serving base station, an indication to be precluded from RACH-less hard switch and to perform a new random access channel.

18. The apparatus of claim 1, wherein the at least one non-transitory memory storing instructions is executed by the at least one processor to cause the apparatus at least to:
receive, from the communication network, an indication of the point in time to create the pre-compensation transition window.

19. A method, comprising:
based on determining an routing point switch in a communication network by a serving base station from a source routing point to a target routing point;
creating a pre-compensation transition window for start and end of transition time between an availability of the source routing point and an availability of the target routing point,
wherein the creating is starting at a point in time and using a duration of the pre-compensation transition window on at least an uplink transmission with the target routing point and at least a downlink reception from the source routing point; and
based on the pre-compensation transition window, performing at least one of time or frequency pre-compensation to accommodate for time differences at the serving base station at least one of during or after the routing point switch or for differences in a propagation path between the source routing point and the target routing point to at least maintain continuity of communication by the apparatus during the start and end of transition time.
